(19) United States
(12) Patent Application Publication
(10) Pub. No.: US 2023/0001595 A1
(43) Pub. Date: Jan. 5, 2023

(54) SECONDARY BATTERY POUCH CUTTER AND ASSEMBLING METHOD THEREOF

(71) Applicant: MPLUS CORP, Cheongju-si, Chungcheongbuk-do (KR)

(72) Inventors: Jong Sung KIM, Seongnam-si (KR); Kang Ho KO, Yongin-si (KR)

(73) Assignee: MPLUS CORP, Cheongju-si, Chungcheongbuk-do (KR)

(21) Appl. No.: 17/784,440

(22) PCT Filed: Jun. 19, 2020
(86) PCT No.: PCT/KR2020/007993

§ 371 Date: Jun. 10, 2022

(30) Foreign Application Priority Data
Dec. 12, 2019 (KR) 10-2019-0166052

(51) Int. Cl. B26D 1/00; B26D 7/26

(52) U.S. Cl. CPC B26D 1/0006; B26D 7/2614; B26D 2001/0053; B26D 2001/0066; B26D 1/04

(57) ABSTRACT

Proposed is a pouch cutter for a secondary battery. The pouch cutter includes a bottom knife (20) having a blade and a top knife (30) having a blade disposed to be adjacent to the blade of the bottom knife (20), wherein the blade of the bottom knife (20) and/or the blade of the top knife (30) are formed at an acute angle, the bottom knife (20) and the top knife (30) are cutters having a square cross section, and at least the top knife (30) from among the top knife (30) and the bottom knife (20) has a first top knife blade (35A), a second top knife blade (35B), a third top knife blade (35C), and a fourth top knife blade (35D), which are formed at an acute angle so as to be adjacent to four corners of the top knife.

### TECHNICAL FIELD

The present disclosure relates to a pouch cutter for a secondary battery and an assembly method therefor, the pouch cutter having a new structure configured to have longer lifespan, to prevent the degradation in the pouch cutting quality, and to prevent fusion of pouches when two pouches are cut while being overlapped with each other.

### BACKGROUND ART

Demand for secondary batteries as an energy source for mobile devices such as cell phones has rapidly increased. Among these secondary batteries, lithium secondary batteries having characteristics of high energy density, operating potential, long life cycle, and low self-discharge rate have been commercialized and widely used.

The lithium secondary batteries can be divided into a prismatic lithium secondary battery and a pouch lithium secondary battery according to the shape. Among these lithium secondary batteries, the lithium secondary battery is manufactured by inserting an electrode assembly having a porous separator disposed between a positive electrode and a negative electrode thereof into a pouch case having predetermined size and shape, and then performing impregnation by injecting an electrolyte containing lithium salt.

At this time, a process of cutting the pouch into which the electrode assembly is inserted by a cutter is required.

In a conventional pouch cutter shown in FIG. 1, a bottom knife is formed at 90°, a top knife is formed at an acute angle, and a shear angle is arbitrarily applied to the top knife. A blade of the bottom knife is formed at 90° and a blade of the top knife is formed at an acute angle.

The conventional pouch cutter shown in FIG. 1 has no particular problem in cutting quality, but requires frequent replacement due to short lifespan thereof.

FIG. 2 is a view showing a pouch cutter currently in use, and a top knife is formed at 90°, a bottom knife is also formed at 90°, and a shear angle is mounting the top knife inclined at a predetermined angle. A blade of the top knife is formed at 90° and a blade of the bottom knife is also formed at 90°.

The pouch cutter shown in FIG. 2 can utilize all four corners thereof, so that there is an effect of increasing the lifespan thereof by 4 times.

However, since both the blade angle of the top knife and the blade angle of the bottom knife are 90°, there are problems in that the shear load is large during pouch cutting, and the quality of the pouch cutting is deteriorated even if a little wear of the blade occurs. In a severe case, when two overlapped pouches are cut, there is a problem in that pouch cut edges adhere to each other and are not separated from each other. When the two overlapped pouches are cut, the shear load significantly acts and thus the two pouches are attached to each other, so that there is a problem in that the two pouches are not properly separated from each other due to a portion where the two pouches are attached to each other.

### DISCLOSURE

### Technical Problem

The present disclosure is intended to provide a pouch cutter for a secondary battery and an assembly method therefor, wherein the pouch cutter having a new structure is configured to have extended lifespan, to prevent the degradation in pouch cutting quality, and to prevent, even when two pouches are cut while being overlapped with each other, the two pouches from being attached to each other and being inseparable.

### Technical Solution

In order to achieve the above objective, according to the present disclosure, there is provided to a pouch cutter for a secondary battery, wherein the pouch cutter may include: a bottom knife having a blade; and a top knife having a blade disposed to be adjacent to the blade of the bottom knife, wherein at least one blade from among the blade of the bottom knife and the blade of the top knife may be formed at an acute angle.

Advantageous Effects

According to the present disclosure, the pouch cutter for a secondary battery includes at least the top knife blade or the bottom knife blade from among the top knife and the bottom knife, which is formed at an acute angle, so that the shear load is reduced while pouch cutting and it is possible to prevent pouch cut edges from adhering to each other.

### DESCRIPTION OF DRAWINGS

FIGS. 1 and 2 are view schematically showing a structure of a conventional pouch cutter.

FIG. 3 is an enlarged-perspective view showing a part of a top knife, i.e., a main part of a pouch cutter for a secondary battery according to the present disclosure.

FIG. 4 is a perspective view showing a structure of the pouch cutter for a secondary battery according to the present disclosure.

FIG. 5 is one side view showing the pouch cutter of FIG. 4.

FIG. 6 is another side view showing the pouch cutter of FIG. 4.

FIG. 7 is a perspective view showing the pouch cutter for a secondary battery according to the present disclosure in combination in which the top knife is formed at a regular angle and a bottom knife is formed at an acute angle.

FIG. 8 is one side view showing the pouch cutter of FIG. 7.

FIG. 9 is another side view showing the pouch cutter of FIG. 7.

FIG. 10 is a perspective view showing the pouch cutter for a secondary battery according to the present disclosure in combination in which the top knife and the bottom knife are formed at acute angles.

FIG. 11 is one side view showing the pouch cutter of FIG. 10.

FIG. 12 is another side view showing the pouch cutter of FIG. 10.

FIG. 13 is a perspective view showing the pouch cutter for a secondary battery shown in FIG. 10 with the bottom knife according to a modified embodiment.

FIG. 14 is one side view showing the pouch cutter of FIG. 13.

FIG. 15 is another side view showing the pouch cutter of FIG. 13.

FIG. 16 is a graph showing the maximum shear load in response to an angle of an acute cutter.

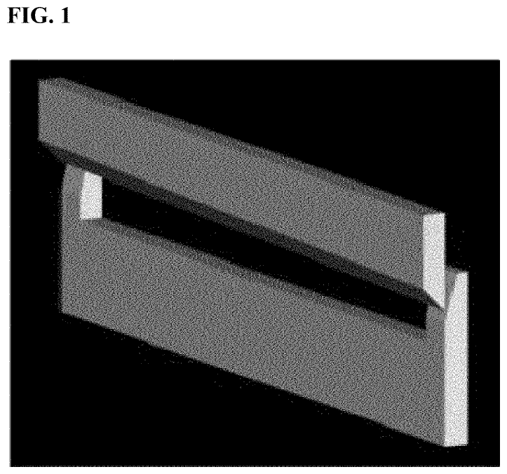

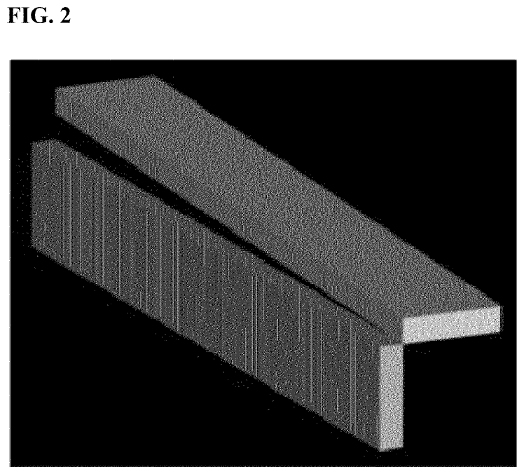

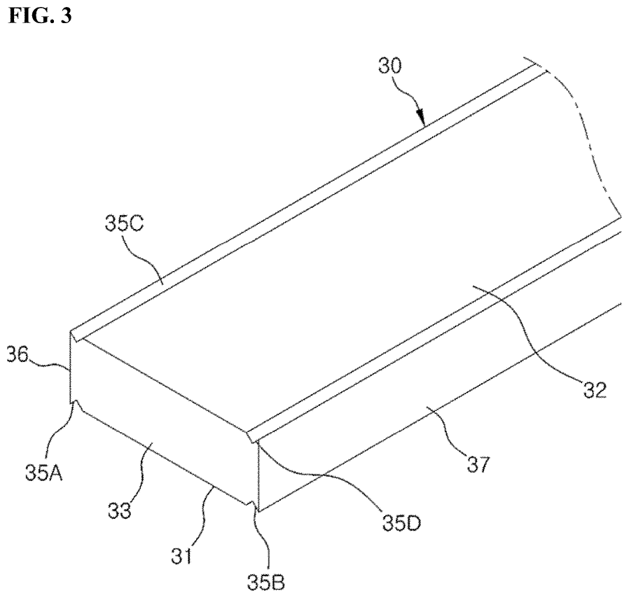

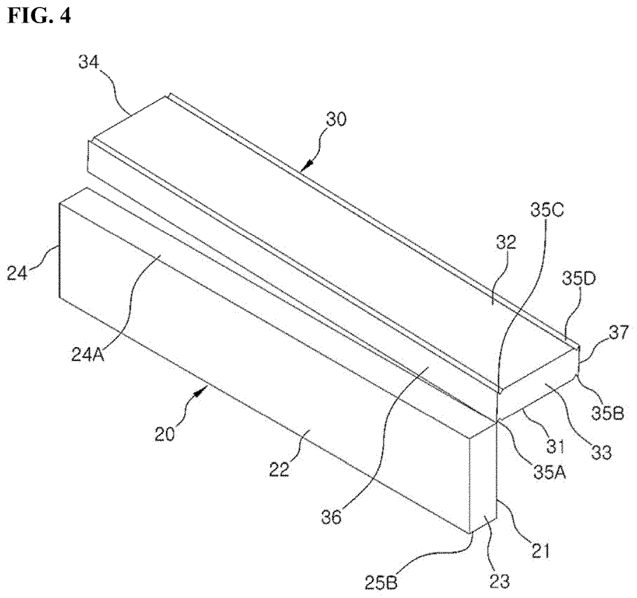

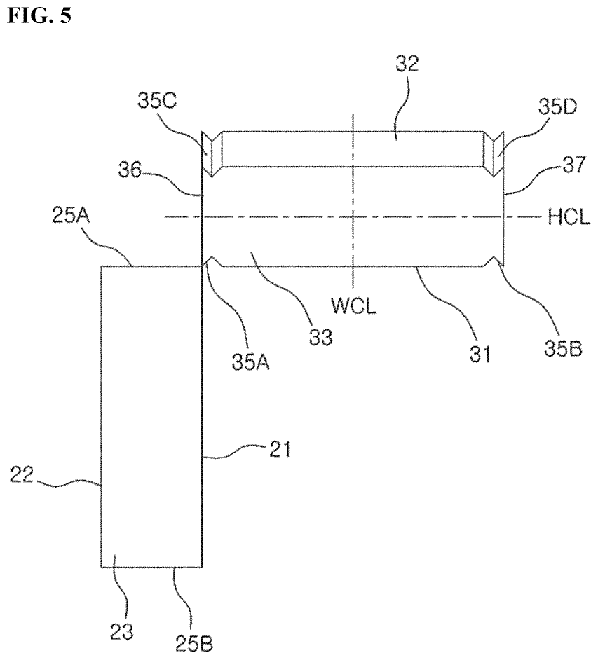

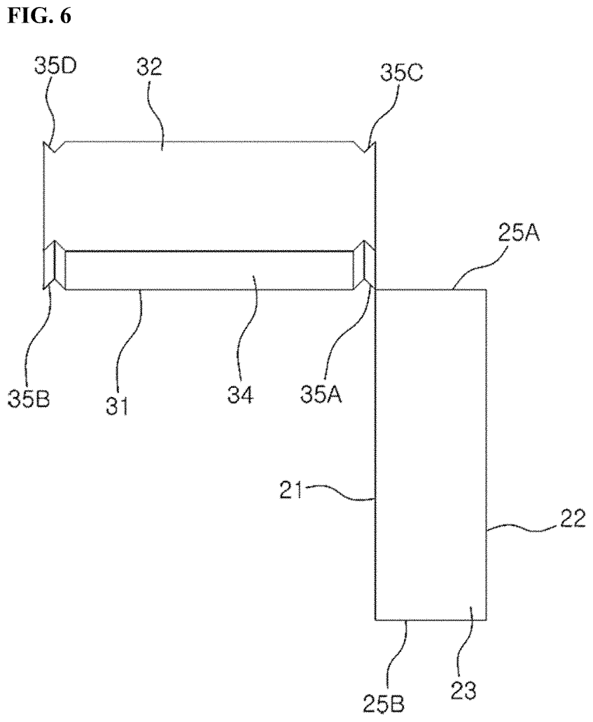

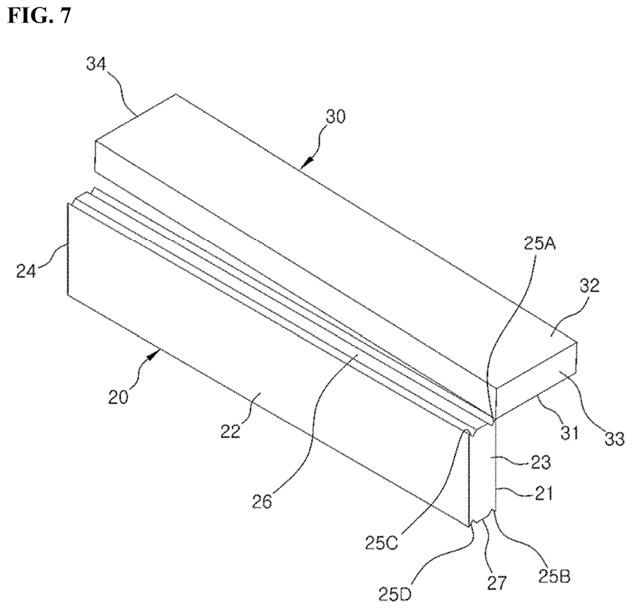

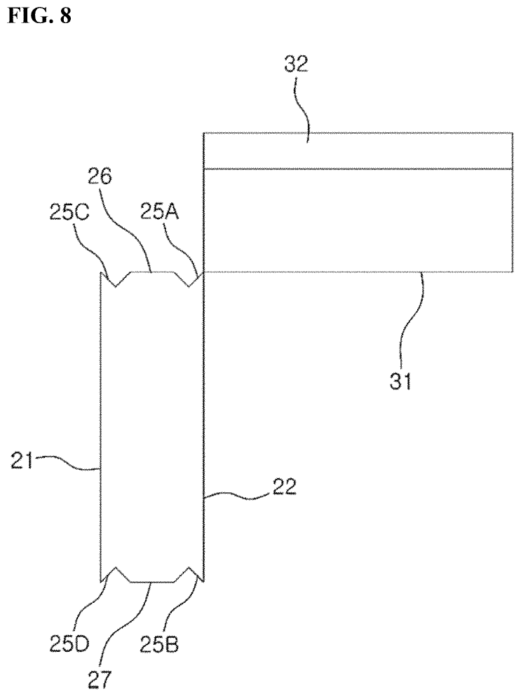

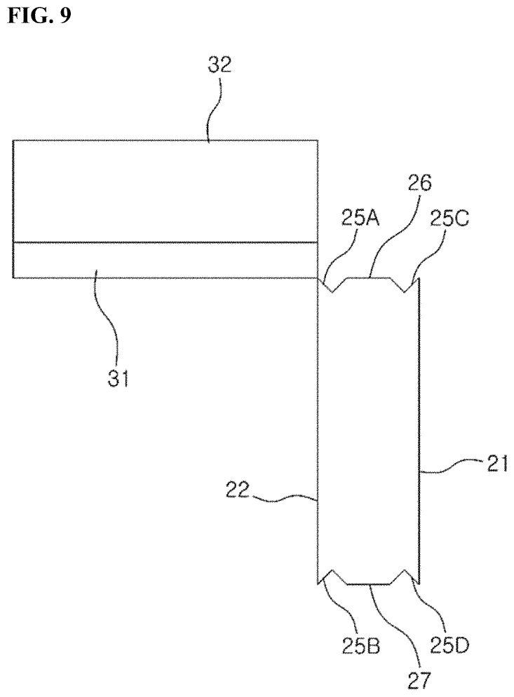

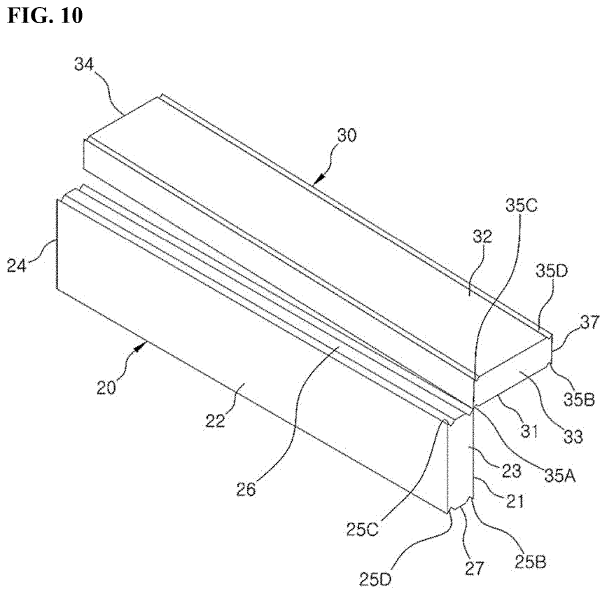

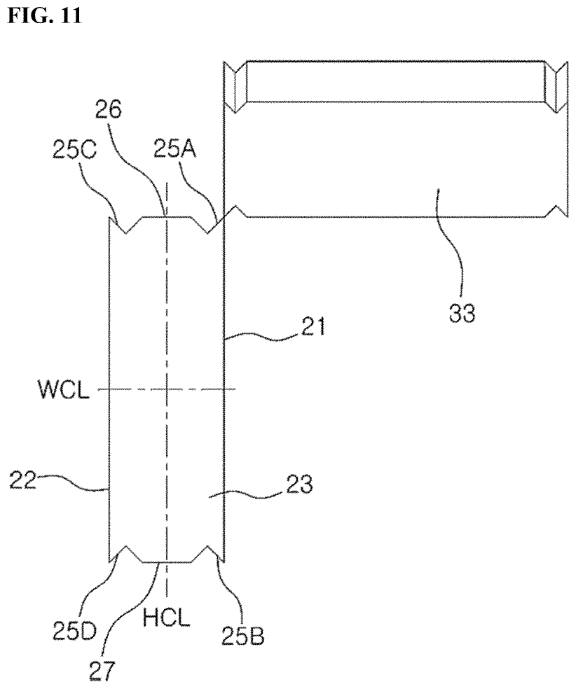

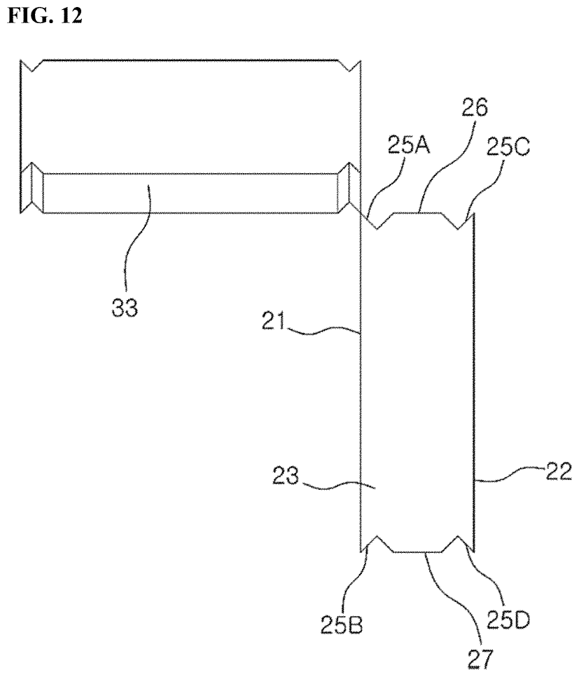

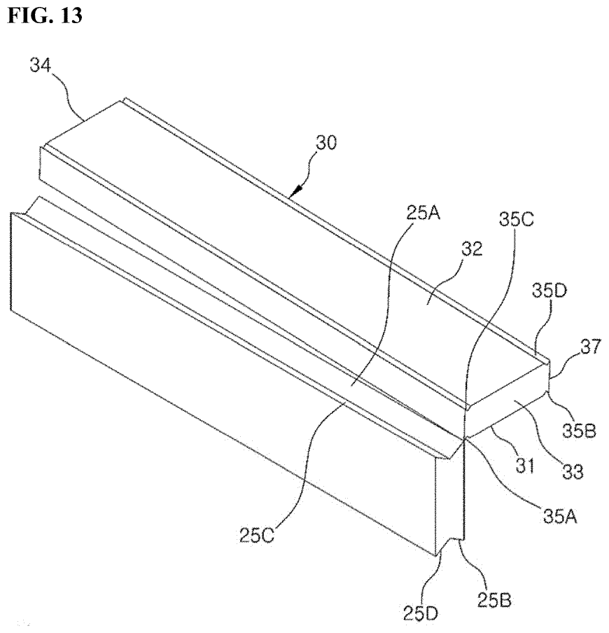

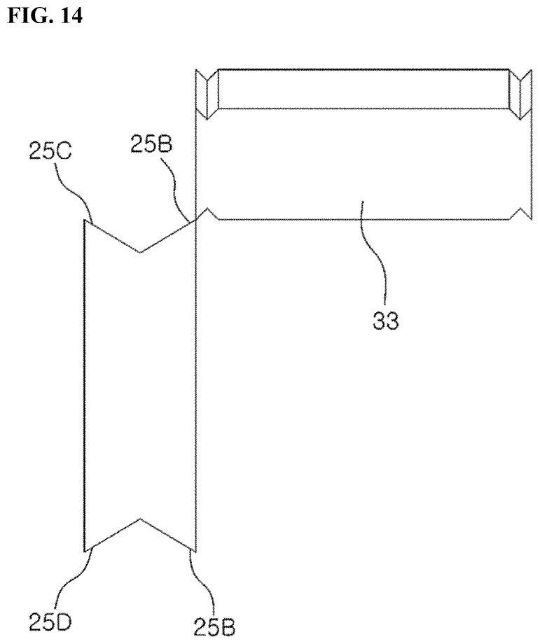

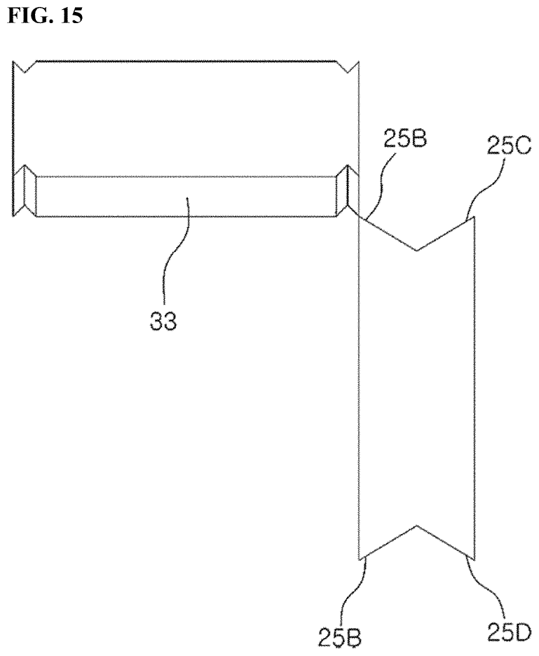

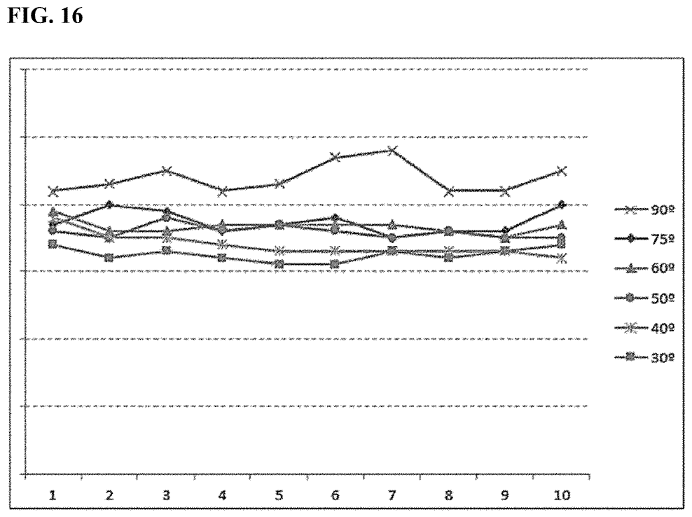

### BEST MODE

According to the present disclosure to solve the above problems, a pouch cutter for a secondary battery includes a bottom knife having a blade; and a top knife having a blade disposed to be adjacent to the blade of the bottom knife. At least one of the blade of the bottom knife and the blade of the top knife is formed at an acute angle, and the bottom knife and the top knife are cutters having square cross sections, and at least the top knife from among the top knife and the bottom knife includes a first top knife blade, a second top knife blade, a third top knife blade, and a fourth top knife blade, which are formed at acute angles so as to be adjacent to four corners thereof.

### MODE FOR INVENTION

A pouch cutter for a secondary battery of the present disclosure includes: a bottom knife 20 having a blade, and a top knife 30 having a blade disposed to be adjacent to the blade of the bottom knife 20, and at least one blade of the blade of the bottom knife 20 and the blade of the top knife 30 is formed at an acute angle. In the present disclosure, as combinations of a cutter, there may be combination in which the top knife 30 is formed at an acute angle and the bottom knife 20 is formed at a regular angle, combination in which and the top knife 30 is formed at a regular angle and the bottom knife 20 is formed at an acute angle, and combination in which both the top knife 30 and the bottom knife 20 are formed at acute angles.

In the present disclosure, the top knife 30 may be formed at the acute angle, and the bottom knife 20 may be formed at the regular angle. Forming the top knife 30 at the acute angle means that a top knife blade located at a corner of the top knife 30 has the acute angle, and forming the bottom knife 20 at the regular angle means that a bottom knife blade provided in the bottom knife 20 has a regular angle.

The bottom knife 20 is a cutter having a square cross section. The bottom knife 20 is a square-cross-sectional cutter having the first bottom knife surface 21 and the second bottom knife surface 22, and a first bottom knife side surface 23, a second bottom knife side surface 24, a first bottom knife blade 25A, and a second bottom knife blade 25B. The first bottom knife blade 25A and the second bottom knife blade 25B are perpendicular to the first bottom knife surface 21 and the second bottom knife surface 22, so that the second bottom knife blade 25B and the second bottom knife blade 25B are formed at acute angles. The bottom knife 20 is disposed in a vertical direction by being supported by a support body such as a support frame.

The top knife 30 is a cutter having a square cross section. The top knife 30 may be disposed in a horizontal direction to be perpendicular to the bottom knife 20 by being coupled thereto with a raising and lowering operation means such as a press machine. The top knife 30 is a square-cross-sectional cutter having a first top knife surface 31, a second top knife surface 32, a first top knife side surface 33, a second top knife side surface 34, a first top knife cross surface 36, and a second top knife cross surface 37. At least the top knife 30 of the bottom knife 20 and the top knife 30 includes a first top knife blade 35A, a second top knife blade 35B, a third top knife blade 35C, and a fourth top knife blade 35D, which are formed at acute angles so as to be adjacent to four corners thereof.

The first top knife blade 35A is formed to be inclined within an acute angular range with respect to the first top knife surface 31. The first top knife blade 35A is formed to be inclined inward at an acute angle with respect to the first top knife surface 31, so that the first top knife blade 35A is arranged at the acute angle. The first top knife blade 35A is formed to be inclined at an acute angle from a first corner of the top knife 30 toward a width center line WCL between the first top knife cross surface 36 and the second top knife cross surface 37 of the top knife 30 when seen from the first top knife side surface 33 or the second top knife side surface 34, so that the first top knife blade 35A is formed at the acute angle. The first top knife blade 35A is formed at an acute angle with respect to the first top knife cross surface 36. An angle between the first top knife blade 35A and the first top knife cross surface 36 is formed at the acute angle.

The second top knife blade 35B is formed to be inclined within an acute angular range with respect to the first top knife surface 31. The second top knife blade 35B is formed to be inclined inward at an acute angle with respect to the first top knife surface 31, so that the second top knife blade 35B is arranged at the acute angle. The second top knife blade 35B is formed to be inclined at an acute angle from a second corner of the top knife 30 toward a width center line WCL between the first top knife cross surface 36 and the second top knife cross surface 37 of the top knife 30 when seen from the first top knife side surface 33 or the second top knife side surface 34, so that the second top knife blade 35B is formed at the acute angle. The second top knife blade 35B is formed at an acute angle with respect to the first top knife cross surface 36. An angle between the second top knife blade 35B and the first top knife cross surface 36 is formed at the acute angle. Based on the width center line WCL between the first top knife cross surface 36 and the second top knife cross surface 37 of the top knife 30, the first top knife blade 35A and the second top knife blade 35B are disposed at symmetric locations. The first top knife blade 35A is formed to be adjacent to the first corner of the top knife 30, and the second top knife blade 35B is disposed to be adjacent to the second corner of the top knife 30.

The third top knife blade 35C is formed to be inclined within an acute angular range with respect to the second top knife surface 32. The third top knife blade 35C is formed to be inclined inward at an acute angle with respect to the second top knife surface 32, so that the third top knife blade 35C is arranged at the acute angle. The third top knife blade 35C is formed to be inclined at the acute angle from a third corner of the top knife 30 toward a width center line WCL between the first top knife cross surface 36 and the second top knife cross surface 37 of the top knife 30 when seen from the first top knife side surface 33 or the second top knife side surface 34, so that the third top knife blade 35C is formed at the acute angle. The third top knife blade 35C is formed at an acute angle with respect to the second top knife cross surface 37. An angle between the third top knife blade 35C and the second top knife cross surface 37 is formed at the acute angle. Based on a height center line HCL between the first top knife surface 31 and the second top knife surface 32 of the top knife 30, the third top knife blade 35C and the first top knife blade 35A are disposed to be symmetric.

The fourth top knife blade 35D is also formed to be inclined within an acute angular range with respect to the second top knife surface 32. The fourth top knife blade 35D is formed to be inclined inward at an acute angle with respect to the second top knife surface 32, so that the fourth top knife blade 35D is arranged at the acute angle. The fourth top knife blade 35D is formed to be inclined at an acute angle from a fourth corner of the top knife 30 toward a width center line WCL between the first top knife cross surface 36 and the second top knife cross surface 37 of the top knife 30 when seen from the first top knife side surface 33 or the second top knife side surface 34, so that the fourth top knife blade 35D is formed at the acute angle. The fourth top knife blade 35D is formed at an acute angle with respect to the second top knife cross surface 37. An angle between the fourth top knife blade 35D and the second top knife cross surface 37 is formed at the acute angle. Based on the width center line WCL between the first top knife cross surface 36 and the second top knife cross surface 37 of the top knife 30, the third top knife blade 35C and the fourth top knife blade 35D are disposed at symmetric locations. The third top knife blade 35C is formed to be adjacent to the third corner of the top knife 30, and the fourth top knife blade 35D is disposed to be adjacent to the fourth corner of the top knife 30. Based on the height center line HCL between the first top knife surface 31 and the second top knife surface 32 of the top knife 30, the fourth top knife blade 35D and the second top knife blade 35B are disposed to be symmetric.

The bottom knife 20 is disposed in a vertical direction, and the top knife 30 is disposed in a horizontal direction to be perpendicular to the bottom knife 20 and at the same time the top knife 30 is disposed while being inclined at a predetermined angle with respect to the bottom knife 20. Disposing the top knife 30 at the predetermined angle means that the top knife 30 is disposed to be inclined such that the height of the first top knife side surface 33 and the height of the second top knife side surface 34 of the top knife 30 are different with respect to the bottom knife 20. The top knife 30 is disposed in a direction perpendicular to the bottom knife 20, and at the same time, when seen from the first bottom knife surface 21 or the second bottom knife surface 22 of the bottom knife 20, the second top knife side surface 34 of the top knife 30 is disposed at a higher location than the first top knife side surface 33. The first top knife side surface 33 of the top knife 30 is disposed to be higher than the second top knife side surface 34 when seen from the first bottom knife surface 21 or the second bottom knife surface 22 of the bottom knife 20, so that the top knife 30 is disposed to be inclined upward with respect to the bottom knife 20. Furthermore, the top knife 30 is disposed to be perpendicular to the bottom knife 20, and at the same time, the first top knife side surface 33 of the top knife 30 may be disposed at the higher location than the second top knife side surface 34 when seen from the first bottom knife surface 21 or the second bottom knife surface 22 of the bottom knife 20. The second top knife side surface 34 of the top knife 30 is higher than the first top knife side surface 33 when seen from the first bottom knife surface 21 or the second bottom knife surface 22 of the bottom knife 20, so that the top knife 30 has a structure in which the top knife is disposed to be inclined upward with respect to the bottom knife 20.

An edge of one top knife blade of the first top knife blade 35A, the second top knife blade 35B, the third top knife blade 35C, and the fourth top knife blade 35D of the top knife 30 may be disposed to be adjacent to a first bottom knife blade 25A or the second bottom knife blade 25B of the bottom knife 20.

The first top knife blade 35A that is adjacent to the first corner of the top knife 30 may be disposed to be adjacent to one edge of the first bottom knife blade 25A of the bottom knife 20, and by rotating the direction of the top knife 30, the second top knife blade 35B that is adjacent to the second corner of the top knife 30 may be disposed to be adjacent to one end of the first bottom knife blade 25A of the bottom knife 20.

Furthermore, the third top knife blade 35C that is adjacent to the third corner of the top knife 30 may be disposed to be adjacent to one edge of the first bottom knife blade 25A of the bottom knife 20, and by rotating the direction of the top knife 30, the fourth top knife blade 35D that is adjacent to the fourth corner of the top knife 30 may be disposed to be adjacent to one edge of the first bottom knife blade 25A of the bottom knife 20.

Meanwhile, the first top knife blade 35A that is adjacent to the first corner of the top knife 30 may be disposed to be adjacent to another edge of the first bottom knife blade 25A of the bottom knife 20, and the second top knife blade 35B that is adjacent to the second corner of the top knife 30 may be disposed to be adjacent to another end of the first bottom knife blade 25A of the bottom knife 20.

Furthermore, the third top knife blade 35C that is adjacent to the third corner of the top knife 30 may be disposed to be adjacent to another edge of the first bottom knife blade 25A of the bottom knife 20, and the fourth top knife blade 35D that is adjacent to the fourth corner of the top knife 30 may be disposed to be adjacent to another edge of the first bottom knife blade 25A of the bottom knife 20.

Furthermore, the first top knife blade 35A that is adjacent to the first corner of the top knife 30 may be disposed to be adjacent to one edge of the second bottom knife blade 25B of the bottom knife 20, and the second top knife blade 35B that is adjacent to the second corner of the top knife 30 may be disposed to be adjacent to one end of the second bottom knife blade 25B of the bottom knife 20.

Furthermore, the third top knife blade 35C that is adjacent to the third corner of the top knife 30 may be disposed to be adjacent to one edge of the second bottom knife blade 25B of the bottom knife 20, and the fourth top knife blade 35D that is adjacent to the fourth corner of the top knife 30 may be disposed to be adjacent to one edge of the second bottom knife blade 25B of the bottom knife 20.

Meanwhile, the first top knife blade 35A that is adjacent to the first corner of the top knife 30 may be disposed to be adjacent to another edge of the second bottom knife blade 25B of the bottom knife 20, and the second top knife blade 35B that is adjacent to the second corner of the top knife 30 may be disposed to be adjacent to another end of the second bottom knife blade 25B of the bottom knife 20.

Furthermore, the third top knife blade 35C that is adjacent to the third corner of the top knife 30 may be disposed to be adjacent to another edge of the second bottom knife blade 25B of the bottom knife 20, and the fourth top knife blade 35D that is adjacent to the fourth corner of the top knife 30 may be disposed to be adjacent to another edge of the second bottom knife blade 25B of the bottom knife 20.

The top knife 30 may be connected to a raising and lowering device such as a press machine (not shown) and to be raised and lowered with respect to the bottom knife 20 by operation of the raising and lowering device.

In combination in which the top knife 30 is formed at the acute angle and the bottom knife 20 is formed at the regular angle, as the top knife 30 is lowered, a pouch may be cut by both the bottom knife blade of the bottom knife 20 and the top knife blade of the top knife 30.

When the first top knife blade 35A of the top knife 30 is disposed to be adjacent to one edge of the first bottom knife blade 25A of the bottom knife 20, as the top knife 30 is lowered, the pouch is cut by both the first bottom knife blade 25A of the bottom knife 20 and the first top knife blade 35A with the acute angle of the top knife 30.

When the second top knife blade 35B of the top knife 30 is disposed to be adjacent to one edge of the first bottom knife blade 25A of the bottom knife 20, as the top knife 30 is lowered, the pouch is cut by both the first bottom knife blade 25A of the bottom knife 20 and the second top knife blade 35B with the acute angle of the top knife 30.

When the third top knife blade 35C of the top knife 30 is disposed to be adjacent to one edge of the first bottom knife blade 25A of the bottom knife 20, as the top knife 30 is lowered, the pouch is cut by both the first bottom knife blade 25A of the bottom knife 20 and the third top knife blade 35C with the acute angle of the top knife 30.

When the fourth top knife blade 35D of the top knife 30 is disposed to be adjacent to one edge of the first bottom knife blade 25A of the bottom knife 20, as the top knife 30 is lowered, the pouch is cut by both the first bottom knife blade 25A of the bottom knife 20 and the fourth top knife blade 35D with the acute angle of the top knife 30.

Meanwhile, when the first top knife blade 35A of the top knife 30 is disposed to be adjacent to another edge of the first bottom knife blade 25A of the bottom knife 20, as the top knife 30 is lowered, the pouch is cut by both the first bottom knife blade 25A of the bottom knife 20 and the first top knife blade 35A with the acute angle of the top knife 30.

When the second top knife blade 35B of the top knife 30 is disposed to be adjacent to another edge of the first bottom knife blade 25A of the bottom knife 20, as the top knife 30 is lowered, the pouch is cut by both the first bottom knife blade 25A of the bottom knife 20 and the second top knife blade 35B with the acute angle of the top knife 30.

When the third top knife blade 35C of the top knife 30 is disposed to be adjacent to another edge of the first bottom knife blade 25A of the bottom knife 20, as the top knife 30 is lowered, the pouch is cut by both the first bottom knife blade 25A of the bottom knife 20 and the third top knife blade 35C with the acute angle of the top knife 30.

When the fourth top knife blade 35D of the top knife 30 is disposed to be adjacent to another edge of the first bottom knife blade 25A of the bottom knife 20, as the top knife 30 is lowered, the pouch is cut by both the first bottom knife blade 25A of the bottom knife 20 and the fourth top knife blade 35D with the acute angle of the top knife 30.

Meanwhile, the pouch is cut by both the second bottom knife blade 25B of the bottom knife 20 and the first top knife blade 35D to the fourth top knife blade 35D of the top knife 30.

When the first top knife blade 35A of the top knife 30 is disposed to be adjacent to one edge of the second bottom knife blade 25B of the bottom knife 20, as the top knife 30 is lowered, the pouch is cut by both the second bottom knife blade 25B of the bottom knife 20 and the first top knife blade 35A with the acute angle of the top knife 30.

When the second top knife blade 35B of the top knife 30 is disposed to be adjacent to one edge of the second bottom knife blade 25B of the bottom knife 20, as the top knife 30 is lowered, the pouch is cut by both the second bottom knife blade 25B of the bottom knife 20 and the second top knife blade 35B with the acute angle of the top knife 30.

When the third top knife blade 35C of the top knife 30 is disposed to be adjacent to one edge of the second bottom knife blade 25B of the bottom knife 20, as the top knife 30 is lowered, the pouch is cut by both the second bottom knife blade 25B of the bottom knife 20 and the third top knife blade 35C with the acute angle of the top knife 30.

When the fourth top knife blade 35D of the top knife 30 is disposed to be adjacent to one edge of the second bottom knife blade 25B of the bottom knife 20, as the top knife 30 is lowered, the pouch is cut by both the second bottom knife blade 25B of the bottom knife 20 and the fourth top knife blade 35D with the acute angle of the top knife 30.

Meanwhile, when the first top knife blade 35A of the top knife 30 is disposed to be adjacent to another edge of the second bottom knife blade 25B of the bottom knife 20, as the top knife 30 is lowered, the pouch is cut by both the second bottom knife blade 25B of the bottom knife 20 and the first top knife blade 35A with the acute angle of the top knife 30.

When the second top knife blade 35B of the top knife 30 is disposed to be adjacent to another edge of the second bottom knife blade 25B of the bottom knife 20, as the top knife 30 is lowered, the pouch is cut by both the second bottom knife blade 25B of the bottom knife 20 and the second top knife blade 35B with the acute angle of the top knife 30.

When the third top knife blade 35C of the top knife 30 is disposed to be adjacent to another edge of the second bottom knife blade 25B of the bottom knife 20, as the top knife 30 is lowered, the pouch is cut by both the second bottom knife blade 25B of the bottom knife 20 and the third top knife blade 35C with the acute angle of the top knife 30.

When the fourth top knife blade 35D of the top knife 30 is disposed to be adjacent to another edge of the second bottom knife blade 25B of the bottom knife 20, as the top knife 30 is lowered, the pouch is cut by both the second bottom knife blade 25B of the bottom knife 20 and the fourth top knife blade 35D with the acute angle of the top knife 30.

In the present disclosure, the top knife 30 may be formed at the regular angle, and the bottom knife 20 may be formed at the acute angle. Forming the bottom knife 20 at the acute angle means that a bottom knife blade located at a corner of the bottom knife 30 has the acute angle, and forming the top knife 30 at the regular angle means that a top knife blade provided in the top knife 30 has a regular angle.

The top knife 30 is a cutter having a square cross section. The top knife 30 is a square-cross-sectional cutter having the first top knife surface 31, the second top knife surface 32, the first top knife side surface 33, the second top knife side surface 34, the first top knife blade 35A, and the second top knife blade 35B. The first top knife blade 35A and the second top knife blade 35B are perpendicular to the first top knife surface 31 and the second top knife surface 32, so that each of the first top knife blade 35A and the second top knife blade 35B is formed at the regular angle.

The bottom knife 20 is a cutter having a square cross section. The bottom knife 20 is a square-cross-sectional cutter having the first bottom knife surface 21, the second bottom knife surface 22, the first bottom knife side surface 23, the second bottom knife side surface 24, a first bottom knife cross surface 26, and a second bottom knife cross surface 27. At least the bottom knife 20 of the bottom knife 20 and the top knife 30 includes the first bottom knife blade 25A, the second bottom knife blade 25B, a third bottom knife blade 25C, and a fourth bottom knife blade 25D, which are disposed to adjacent to four corners thereof.

The first bottom knife blade 25A is formed to be inclined within an acute angular range with respect to the first bottom knife cross surface 26. The first bottom knife blade 25A is formed to be inclined inward at an acute angle with respect to the first bottom knife cross surface 26, so that the second bottom knife blade 25B is arranged at the acute angle. The first bottom knife blade 25A is formed to be inclined inward at the acute angle from a first corner of the bottom knife 20 toward a height center line HCL between the first bottom knife surface 21 and the second bottom knife surface 22 of the bottom knife 20 when seen from the first bottom knife side surface 23 or the second bottom knife side surface 24, so that the second bottom knife blade 25B is arranged at the acute angle. The first bottom knife blade 25A is formed at an acute angle with respect to the first bottom knife surface 21. An angle between the second bottom knife blade 25B and the first bottom knife surface 21 is formed at an acute angle.

The second bottom knife blade 25B is formed to be inclined within an acute angular range with respect to the second bottom knife cross surface 27. The second bottom knife blade 25B is formed to be inclined inward at an acute angle with respect to the second bottom knife cross surface 27, so that the second bottom knife blade 25B is arranged at the acute angle. The second bottom knife blade 25B is formed to be inclined inward at the acute angle from a second corner of the bottom knife 20 toward a height center line HCL between the first bottom knife surface 21 and the second bottom knife surface 22 of the bottom knife 20 when seen from the first bottom knife side surface 23 of the bottom knife 20 or the second bottom knife side surface 24, so that the second bottom knife blade 25B is arranged at the acute angle. The second bottom knife blade 25B is formed at an acute angle with respect to the first bottom knife surface 21. An angle between the second bottom knife blade 25B and the first bottom knife surface 21 is formed at an acute angle. Based on the width center line WCL between the first bottom knife cross surface 26 and the second bottom knife cross surface 27 of the bottom knife 30, the first bottom knife blade 25A and the second bottom knife blade 25B are disposed at symmetric locations.

The first bottom knife blade 25A is formed to be adjacent to the first corner of the bottom knife 20, and the second bottom knife blade 25B is disposed to be adjacent to the second corner of the bottom knife 30.

The third bottom knife blade 25C is formed to be inclined within an acute angular range with respect to the first bottom knife cross surface 26. The third bottom knife blade 25C is formed to be inclined inward at an acute angle with respect to the first bottom knife cross surface 26, so that the third bottom knife blade 25C is arranged at the acute angle. The third bottom knife blade 25C is formed to be inclined at the acute angle from a third corner of the bottom knife 20 toward a height center line HCL between the first bottom knife surface 21 and the second bottom knife surface 22 of the bottom knife 20 when seen from the first bottom knife side surface 23 or the second bottom knife side surface 24, so that the third bottom knife blade 25C is arranged at the acute angle. The third bottom knife blade 25C is formed at an acute angle with respect to the second bottom knife surface 22. An angle between the third bottom knife blade 25C and the second bottom knife surface 22 is formed at an acute angle. Based on the height center line HCL between the first bottom knife surface 21 and the second bottom knife surface 22 of the bottom knife 20, the third bottom knife blade 25C and the second bottom knife blade 25B are disposed at symmetric locations.

The fourth bottom knife blade 25D is also formed to be inclined within an acute angular range with respect to the second bottom knife cross surface 27. The fourth bottom knife blade 25D is formed to be inclined inward at an acute angle with respect to the second bottom knife cross surface 27, so that the fourth bottom knife blade 25D is arranged at the acute angle. The fourth bottom knife blade 25D is formed to be inclined at the acute angle from a fourth corner of the bottom knife 20 toward a height center line HCL between the first bottom knife surface 21 and the second bottom knife surface 22 of the bottom knife 20 when seen from the first bottom knife side surface 23 or the second bottom knife side surface 24, so that the fourth bottom knife blade 25D is arranged at the acute angle. The fourth bottom knife blade 25D is formed at an acute angle with respect to the second bottom knife surface 22. An angle between the fourth bottom knife blade 25D and the second bottom knife surface 22 is formed at an acute angle. Based on the height center line HCL between the first bottom knife surface 21 and the second bottom knife surface 22 of the bottom knife 20, the third bottom knife blade 25C and the fourth bottom knife blade 25D are disposed at symmetric locations. The third bottom knife blade 25C is formed to be adjacent to the third corner of the bottom knife 20, and the fourth bottom knife blade 25D is disposed to be adjacent to the fourth corner of the bottom knife 30.

The bottom knife 20 is disposed in the vertical direction, and the top knife 30 is disposed in the horizontal direction to be perpendicular to the bottom knife 20 and at the same time the top knife 30 is disposed while being inclined at the predetermined angle with respect to the bottom knife 20. The top knife 30 is disposed in the direction perpendicular to the bottom knife 20, and at the same time, the second top knife side surface 34 of the top knife 30 is disposed at the higher location than the first top knife side surface 33 when seen from the first bottom knife surface 21 or the second bottom knife surface 22 of the bottom knife 20. The second top knife side surface 34 of the top knife 30 is higher than the first top knife side surface 33 when seen from the first bottom knife surface 21 or the second bottom knife surface 22 of the bottom knife 20, so that the top knife 30 has a structure in which the top knife is disposed to be inclined upward with respect to the bottom knife 20. Furthermore, the top knife 30 is disposed to be perpendicular to the bottom knife 20, and at the same time, the first top knife side surface 33 of the top knife 30 may be disposed at the higher location than the second top knife side surface 34 when seen from the first bottom knife surface 21 or the second bottom knife surface 22 of the bottom knife 20. The first top knife side surface 33 of the top knife 30 is higher than the second top knife side surface 34 when seen from the first bottom knife surface 21 or the second bottom knife surface 22 of the bottom knife 20, so that the top knife 30 is disposed to be inclined upward with respect to the bottom knife 20.

An edge of any one bottom knife blade of the second bottom knife blade 25B, the second bottom knife blade 25B, the third bottom knife blade 25C, and the fourth bottom knife blade 25D of the bottom knife 20 is disposed to be adjacent to an edge of the first top knife blade 35A or the second top knife blade 35B of the top knife 30.

One edge of the first top knife blade 35A of the top knife 30 may be disposed to be adjacent to the first bottom knife blade 25A adjacent to the first corner of the bottom knife 20, and one edge of the first top knife blade 35A of the top knife 30 may be disposed to be adjacent to the second bottom knife blade 25B adjacent to the second corner of the bottom knife 20.

Furthermore, one edge of the first top knife blade 35A of the top knife 30 may be disposed to be adjacent to the third bottom knife blade 25C adjacent to the third corner of the bottom knife 20, and one edge of the first top knife blade 35A of the top knife 30 may be disposed to be adjacent to the fourth bottom knife blade 25D adjacent to the fourth corner of the bottom knife 20.

Meanwhile, another edge of the first top knife blade 35A of the top knife 30 may be disposed to be adjacent to the first bottom knife blade 25A adjacent to the first corner of the bottom knife 20, and another edge of the first top knife blade 35A of the top knife 30 may be disposed to be adjacent to the second bottom knife blade 25B adjacent to the second corner of the bottom knife 20.

Furthermore, the another edge of the first top knife blade 35A of the top knife 30 may be disposed to be adjacent to the third bottom knife blade 25C adjacent to the third corner of the bottom knife 20, and another edge of the second top knife blade 35B of the top knife 30 may be disposed to be adjacent to the fourth bottom knife blade 25D adjacent to the fourth corner of the bottom knife 20.

Meanwhile, the second top knife blade 35B of the top knife 30 may be disposed to be adjacent to the first to fourth bottom knife blades 25A to 25D of the bottom knife 20.

One edge of the second top knife blade 35B of the top knife 30 may be disposed to be adjacent to the first bottom knife blade 25A adjacent to the first corner of the bottom knife 20, and one edge of the second top knife blade 35B of the top knife 30 may be disposed to be adjacent to the second bottom knife blade 25B adjacent to the second corner of the bottom knife 20.

Furthermore, one edge of the second top knife blade 35B of the top knife 30 may be disposed to be adjacent to the third bottom knife blade 25C adjacent to the third corner of the bottom knife 20, and one edge of the second top knife blade 35B of the top knife 30 may be disposed to be adjacent to the fourth bottom knife blade 25D adjacent to the fourth corner of the bottom knife 20.

Meanwhile, another edge of the second top knife blade 35B of the top knife 30 may be disposed to be adjacent to the first bottom knife blade 25A adjacent to the first corner of the bottom knife 20, and another edge of the second top knife blade 35B of the top knife 30 may be disposed to be adjacent to the second bottom knife blade 25B adjacent to the second corner of the bottom knife 20.

Furthermore, another edge of the second top knife blade 35B of the top knife 30 may be disposed to be adjacent to the third bottom knife blade 25C adjacent to the third corner of the bottom knife 20, and another edge of the second top knife blade 35B of the top knife 30 may be disposed to be adjacent to the fourth bottom knife blade 25D adjacent to the fourth corner of the bottom knife 20.

Even when the top knife 30 is formed at a regular angle, and the bottom knife 20 is formed at an acute angle, the top knife 30 is connected to the raising and lowering device such as the press machine (not shown) to be raised and lowered with respect to the bottom knife 20 by operation of the raising and lowering device, and as the top knife 30 is lowered, the pouch may be cut by the bottom knife blade of the bottom knife 20 and the top knife blade of the top knife 30.

When the first bottom knife blade 25A of the bottom knife 20 is disposed to be adjacent to one edge of the first top knife blade 35A of the top knife 30, as the top knife 30 is lowered, the pouch is cut by both the first bottom knife blade 25A with the acute angle of the bottom knife 20 and the first top knife blade 35A of the top knife 30.

When the second bottom knife blade 25B of the bottom knife 20 is disposed to be adjacent to one edge of the first top knife blade 35A of the top knife 30, as the top knife 30 is lowered, the pouch may be cut by the second bottom knife blade 25B with the acute angle of the bottom knife 20 and the first top knife blade 35A of the top knife 30.

When the third bottom knife blade 25C of the bottom knife 20 is disposed to be adjacent to one edge of the first top knife blade 35A of the top knife 30, as the top knife 30 is lowered, the pouch is cut by both the third bottom knife blade 25C with the acute angle of the bottom knife 20 and the first top knife blade 35A of the top knife 30.

When the fourth bottom knife blade 25D of the bottom knife 20 is disposed to be adjacent to one edge of the first top knife blade 35A of the top knife 30, as the top knife 30 is lowered, the pouch is cut by both the fourth bottom knife blade 25D with the acute angle of the bottom knife 20 and the first top knife blade 35A of the top knife 30.

Meanwhile, the pouch may be cut by the second top knife blade 35B of the top knife 30 and the first to fourth bottom knife blades 25A to 25D of the bottom knife 20.

When the first bottom knife blade 25A of the bottom knife 20 is disposed to be adjacent to one edge of the first top knife blade 35A of the top knife 30, as the top knife 30 is lowered, the pouch is cut by both the first bottom knife blade 25A with the acute angle of the bottom knife 20 and the first top knife blade 35A of the top knife 30.

When the second bottom knife blade 25B of the bottom knife 20 is disposed to be adjacent to another edge of the first top knife blade 35A of the top knife 30, as the top knife 30 is lowered, the pouch may be cut by the second bottom knife blade 25B with the acute angle of the bottom knife 20 and the first top knife blade 35A of the top knife 30.

When the third bottom knife blade 25C of the bottom knife 20 is disposed to be adjacent to another edge of the first top knife blade 35A of the top knife 30, as the top knife 30 is lowered, the pouch is cut by both the third bottom knife blade 25C with the acute angle of the bottom knife 20 and the first top knife blade 35A of the top knife 30.

When the fourth bottom knife blade 25D of the bottom knife 20 is disposed to be adjacent to another edge of the first top knife blade 35A of the top knife 30, as the top knife 30 is lowered, the pouch is cut by both the fourth bottom knife blade 25D with the acute angle of the bottom knife 20 and the first top knife blade 35A of the top knife 30.

Meanwhile, the pouch may be cut by the second top knife blade 35B of the top knife 30 and the first to fourth bottom knife blades 25A to 25D of the bottom knife 20.

When the second bottom knife blade 25B of the bottom knife 20 is disposed to be adjacent to one edge of the first top knife blade 35A of the top knife 30, as the top knife 30 is lowered, the pouch is cut by both the first bottom knife blade 25A with the acute angle of the bottom knife 20 and the second top knife blade 35B of the top knife 30.

When the second bottom knife blade 25B of the bottom knife 20 is disposed to be adjacent to one edge of the second top knife blade 35B of the top knife 30, as the top knife 30 is lowered, the pouch may be cut by the second bottom knife blade 25B with the acute angle of the bottom knife 20 and the second top knife blade 35B of the top knife 30.

When the third bottom knife blade 25C of the bottom knife 20 is disposed to be adjacent to one edge of the second top knife blade 35B of the top knife 30, as the top knife 30 is lowered, the pouch is cut by both the second bottom knife blade 25B with the acute angle of the bottom knife 20 and the second top knife blade 35B of the top knife 30.

When the fourth bottom knife blade 25D of the bottom knife 20 is disposed to be adjacent to one edge of the second top knife blade 35B of the top knife 30, as the top knife 30 is lowered, the pouch may be cut by the fourth bottom knife blade 25D with the acute angle of the bottom knife 20 and the second top knife blade 35B of the top knife 30.

Meanwhile, when the second bottom knife blade 25B of the bottom knife 20 is disposed to be adjacent to another edge of the second top knife blade 35B of the top knife 30, as the top knife 30 is lowered, the pouch may be cut by the second bottom knife blade 25B with the acute angle of the bottom knife 20 and the second top knife blade 35B of the top knife 30.

When the first bottom knife blade 25A of the bottom knife 20 is disposed to be adjacent to another edge of the second top knife blade 35B of the top knife 30, as the top knife 30 is lowered, the pouch may be cut by the first bottom knife blade 25A with the acute angle of the bottom knife 20 and the second top knife blade 35B of the top knife 30.

When the third bottom knife blade 25C of the bottom knife 20 is disposed to be adjacent to another edge of the second top knife blade 35B of the top knife 30, as the top knife 30 is lowered, the pouch is cut by both the third bottom knife blade 25C with the acute angle of the bottom knife 20 and the second top knife blade 35B of the top knife 30.

When the fourth bottom knife blade 25D of the bottom knife 20 is disposed to be adjacent to another edge of the second top knife blade 35B of the top knife 30, as the top knife 30 is lowered, the pouch may be cut by the fourth bottom knife blade 25D with the acute angle of the bottom knife 20 and the second top knife blade 35B of the top knife 30.

Furthermore, in the present disclosure, as the four corners of the bottom knife 20 are formed at an acute angle, the top knife 30 may be formed at an acute angle, and the bottom knife 20 may also be formed at an acute angle. Forming the top knife 30 at the acute angle means that a top knife blade located at a corner of the top knife 30 has the acute angle, and forming the bottom knife 20 at the regular angle means that a bottom knife blade provided in the bottom knife 20 has a regular angle.

When the top knife 30 is formed at an acute angle, and the bottom knife 20 is also formed at an acute angle, the top knife 30 has the same structure as the top knife 30 in the case in which the top knife 30 is formed at an acute angle and the bottom knife 20 is formed at a regular angle, so the description of the structure of the top knife 30 in the case in which the top knife 30 is formed at an acute angle and the bottom knife 20 is also formed at an acute angle will be described.

Furthermore, when the top knife 30 is formed at an acute angle, and the bottom knife 20 is also formed at an acute angle, the bottom knife 20 has the same structure as the bottom knife 20 in the case in which the top knife 30 is formed at a regular angle and the bottom knife 20 is formed at an acute angle, so the description of the structure of the bottom knife 20 in the case in which the top knife 30 is formed at an acute angle and the bottom knife 20 is also formed at an acute angle will also be described.

When the top knife 30 is formed at an acute angle and the bottom knife 20 is formed at a regular angle, the bottom knife 20 is disposed in the vertical direction, and the top knife 30 is disposed in the horizontal direction to be perpendicular to the bottom knife 20 and at the same time the top knife 30 is disposed while being inclined at the predetermined angle with respect to the bottom knife 20. In order to locate the second top knife side surface 34 higher than the first top knife side surface 33, the top knife 30 is disposed in the direction perpendicular to the bottom knife 20, and at the same time, the second top knife side surface 34 of the top knife 30 is disposed at the higher location than the first top knife side surface 33 when seen from the first bottom knife surface 21 or the second bottom knife surface 22 of the bottom knife 20. The second top knife side surface 34 of the top knife 30 is higher than the first top knife side surface 33 when seen from the first bottom knife surface 21 or the second bottom knife surface 22 of the bottom knife 20, so that the top knife 30 has a structure in which the top knife is disposed to be inclined upward with respect to the bottom knife 20. Furthermore, the top knife 30 is disposed to be perpendicular to the bottom knife 20, and at the same time, the first top knife side surface 33 of the top knife 30 is disposed at the higher location than the second top knife side surface 34 when seen from the first bottom knife surface 21 or the second bottom knife surface 22 of the bottom knife 20. The first top knife side surface 33 of the top knife 30 is higher than the second top knife side surface 34 when seen from the first bottom knife surface 21 or the second bottom knife surface 22 of the bottom knife 20, so that the top knife 30 is disposed to be inclined upward with respect to the bottom knife 20.

An edge of any one bottom knife blade of the second bottom knife blade 25B, the second bottom knife blade 25B, the third bottom knife blade 25C, and the fourth bottom knife blade 25D of the bottom knife 20 is disposed to be adjacent to an edge of the first top knife blade 35A, the second top knife blade 35B, the third top knife blade 35C, and the fourth top knife blade 35D of the top knife 30.

One of the first to fourth top knife blades 35A to 35D of the top knife 30 may be disposed to be adjacent to the first bottom knife blade 25A adjacent to the first corner of the bottom knife 20, and one of the first to fourth top knife blades 35A to 35D of the top knife 30 may be disposed to be adjacent to the second bottom knife blade 25B adjacent to the second corner of the bottom knife 20.

Furthermore, one of the first to fourth top knife blades 35A to 35D of the top knife 30 may be disposed to be adjacent to the third bottom knife blade 25C adjacent to the third corner of the bottom knife 20, and one of the first to fourth top knife blades 35A to 35D of the top knife 30 may be disposed to be adjacent to the fourth bottom knife blade 25D adjacent to the fourth corner of the bottom knife 20.

Even when the top knife 30 is formed at an acute angle, and the bottom knife 20 is also formed at an acute angle, the top knife 30 is connected to the raising and lowering device such as the press machine (not shown) to be raised and lowered with respect to the bottom knife 20 by operation of the raising and lowering device, and as the top knife 30 is lowered, the pouch may be cut by the bottom knife blade of the bottom knife 20 and the top knife blade of the top knife 30.

When the first top knife blade 35A of the top knife 30 is disposed to be adjacent to the first bottom knife blade 25A of the bottom knife 20, as the top knife 30 is lowered, the pouch is cut by both the first bottom knife blade 25A with the acute angle of the bottom knife 20 and the first top knife blade 35A with the acute angle of the top knife 30.

When the first top knife blade 35A of the top knife 30 is disposed to be adjacent to the second bottom knife blade 25B of the bottom knife 20, as the top knife 30 is lowered, the pouch may be cut by the second bottom knife blade 25B with the acute angle of the bottom knife 20 and the first top knife blade 35A with the acute angle of the top knife 30.

When the first top knife blade 35A of the top knife 30 is disposed to be adjacent to the third bottom knife blade 25C of the bottom knife 20, as the top knife 30 is lowered, the pouch is cut by both the third bottom knife blade 25C with the acute angle of the bottom knife 20 and the first top knife blade 35A with the acute angle of the top knife 30.

When the first top knife blade 35A of the top knife 30 is disposed to be adjacent to the fourth bottom knife blade 25D of the bottom knife 20, as the top knife 30 is lowered, the pouch may be cut by the fourth bottom knife blade 25D with the acute angle of the bottom knife 20 and the first top knife blade 35A with the acute angle of the top knife 30.

Furthermore, the pouch may be cut by the second top knife blade 35B of the top knife 30 and the first to fourth bottom knife blades 25A to 25D of the bottom knife 20.

When the second top knife blade 35B of the top knife 30 is disposed to be adjacent to the second bottom knife blade 25B of the bottom knife 20, as the top knife 30 is lowered, the pouch may be cut by the second bottom knife blade 25B with the acute angle of the bottom knife 20 and the second top knife blade 35B with the acute angle of the top knife 30.

When the second bottom knife blade 25B of the bottom knife 20 is disposed to be adjacent to the second top knife blade 35B of the top knife 30, as the top knife 30 is lowered, the pouch may be cut by the second bottom knife blade 25B with the acute angle of the bottom knife 20 and the second top knife blade 35B with the acute angle of the top knife 30.

When the third bottom knife blade 25C of the bottom knife 20 is disposed to be adjacent to the second top knife blade 35B of the top knife 20, as the top knife 30 is lowered, the pouch is cut by both the third bottom knife blade 25C with the acute angle of the bottom knife 20 and the second top knife blade 35B with the acute angle of the top knife 30.

When the fourth bottom knife blade 25D of the bottom knife 20 is disposed to be adjacent to the second top knife blade 35B of the top knife 30, as the top knife 30 is lowered, the pouch is cut by the fourth bottom knife blade 25D with an acute angle of the bottom knife 20 and the second top knife blade 35B with an acute angle of the top knife 30.

Furthermore, the pouch may be cut by the third top knife blade 35C of the top knife 30 and the first to fourth bottom knife blades 25A to 25D of the bottom knife 20.

When the first bottom knife blade 25A of the bottom knife 20 is disposed to be adjacent to the third top knife blade 35C of the top knife 30, as the top knife 30 is lowered, the pouch is cut by both the first bottom knife blade 25A with the acute angle of the bottom knife 20 and the third top knife blade 35C with the acute angle of the top knife 30.

When the second bottom knife blade 25B of the bottom knife 20 is disposed to be adjacent to the third top knife blade 35C of the top knife 30, as the top knife 30 is lowered, the pouch is cut by both the second bottom knife blade 25B of the bottom knife 20 and the third top knife blade 35C of the top knife 30.

When the third bottom knife blade 25C of the bottom knife 20 is disposed to be adjacent to the third top knife blade 35C of the top knife 30, as the top knife 30 is lowered, the pouch is cut by both the third bottom knife blade 25C of the bottom knife 20 and the third top knife blade 35C of the top knife 30.

When the fourth bottom knife blade 25D of the bottom knife 20 is disposed to be adjacent to the third top knife blade 35C of the top knife 30, as the top knife 30 is lowered, the pouch is cut by both the fourth bottom knife blade 25D of the bottom knife 20 and the third top knife blade 35C of the top knife 30.

Furthermore, the pouch may be cut by the fourth top knife blade 35D of the top knife 30 and the first to fourth bottom knife blades 25A to 25D of the bottom knife 20.

When the first bottom knife blade 25A of the bottom knife 20 is disposed to be adjacent to the fourth top knife blade 35D of the top knife 30, as the top knife 30 is lowered, the pouch is cut by both the first bottom knife blade 25A with the acute angle of the bottom knife 20 and the fourth top knife blade 35D with the acute angle of the top knife 30.

When the second bottom knife blade 25B of the bottom knife 20 is disposed to be adjacent to the fourth top knife blade 35D of the top knife 30, as the top knife 30 is lowered, the pouch is cut by both the second bottom knife blade 25B of the bottom knife 20 and the fourth top knife blade 35D of the top knife 30.

When the third bottom knife blade 25C of the bottom knife 20 is disposed to be adjacent to the third top knife blade 35C of the top knife 30, as the top knife 30 is lowered, the pouch is cut by both the third bottom knife blade 25C of the bottom knife 20 and the fourth top knife blade 35D of the top knife 30.

When the fourth bottom knife blade 25D of the bottom knife 20 is disposed to be adjacent to the fourth top knife blade 35D of the top knife 30, as the top knife 30 is lowered, the pouch is cut by both the fourth bottom knife blade 25D of the bottom knife 20 and the fourth top knife blade 35D of the top knife 30.

Meanwhile, in another embodiment of the present disclosure, the first to fourth bottom knife blades 25A to 25D provided at the four corners of the bottom knife 20 are formed at acute angles, and the first to fourth bottom knife blades of the bottom knife 20 may be configured to be different from the first to fourth bottom knife blades of the bottom knife 20 described above.

In the another embodiment of the present disclosure, the bottom knife 20 includes the first bottom knife blade 25A, the second bottom knife blade 25B, the third bottom knife blade 25C, and the fourth bottom knife blade 25D at the four corners thereof, and the first bottom knife and an inside end of the second bottom knife blade 25B are connected to each other, and the third bottom knife blade 25C and an inside end of the fourth bottom knife blade 25D are connected to each other. The first bottom knife blade 25A and the second bottom knife blade 25B form a wedge bottom knife blade part when seen from the first bottom knife side surface 23 or the second bottom knife side surface 24 of the bottom knife 20, and the third bottom knife blade 25C and the fourth bottom knife blade 25D also form a wedge bottom knife blade part.

Based on the width center line WCL of the bottom knife 20, the first bottom knife blade 25A and the second bottom knife blade 25B are disposed symmetrically to the third bottom knife blade 25C and the fourth bottom knife blade 25D.

According to the another embodiment of the present disclosure, the top knife 30 is configured to be raised and lowered with respect to the bottom knife 20, and as the top knife 30 is lowered, the top knife 30 and the bottom knife 20 cut the pouch. A process of cutting the pouch by the top knife 30 and the bottom knife 20 according to the present disclosure is equal to or similar to the process of cutting the pouch with the top knife 30 disposed at an acute angle and the bottom knife 20 disposed at an acute angle as described above, so the description of the processing of cutting the pouch by the top knife 30 and the bottom knife 20 according to the present disclosure will be omitted.

Furthermore, in the present disclosure, an assembly method in which the top knife 30 and the bottom knife 20 are disposed is provided. The assembly method of the pouch cutter for a secondary battery of the present disclosure includes disposing the bottom knife 20 having a blade, and disposing a blade of the top knife 30 such that the blade of the top knife 30 is adjacent to the blade of the bottom knife 20. In the assembly method of the present disclosure, it is also important to form at least one of the blade of the bottom knife 20 and the blade of the top knife 30 at an acute angle.

In the assembly method of the present disclosure, as described above, the bottom knife 20 is disposed in the vertical direction by being supported by the support body, and the top knife 30 is coupled to the raising and lowering operation means such as the press machine and is disposed in the horizontal direction to be perpendicular to the bottom knife 20. For example, the first top knife blade 35A of the top knife 30 is formed at an acute angle, the bottom knife 20 is disposed in the vertical direction and thus the first bottom knife blade 25A is disposed in the horizontal direction, and the top knife 30 is disposed in the horizontal direction to be perpendicular to the bottom knife 20 and thus the first top knife cross surface 36 of the top knife 30 is disposed in the vertical direction to be perpendicular to the first bottom knife blade 25A of the bottom knife 20.

As described above, the assembly method of the pouch cutter of the present disclosure includes disposing the bottom knife 20 having a blade, and disposing a blade of the top knife 30 such that the blade of the top knife 30 is adjacent to the blade of the bottom knife 20 and at the same time disposing the top knife 30 and the bottom knife 20 in a perpendicular directions to each other. The assembly method is applied in the same way in a case in which a top knife blade of the top knife 30 is formed at a regular angle and a bottom knife blade of the bottom knife 20 is formed at an acute angle, and in a case in which a top knife blade of the top knife 30 is formed at an acute angle and a bottom knife blade of the bottom knife 20 is formed at an acute angle.

The pouch cutter for a secondary battery according to the present disclosure is configured to prevent pouch edges from adhering to each other due to the lowered shear load during pouch cutting by forming at least a top knife blade of the top knife 30 or a bottom knife blade of the bottom knife 20 from among from the top knife 30 and the bottom knife 20 at an acute angle.

The present disclosure is configured to reduce the shear load during pouch cutting by forming any one of a top knife blade of the top knife 30 and a bottom knife blade of the bottom knife 20 at an acute angle, and to solve a quality degradation problem of pouch cutting by, when the blade is worn, replacing the worn blade with other blades. Specifically, when two overlapped pouches are cut, it is possible to prevent cut edges of the pouches from adhering to each other and from being inseparable. When the two overlapped pouches are cut, the two pouches are not attached to each other by heat because the shear load does not significantly act, and the two pouches are prevented from being separated properly due to a portion where the two pouches are attached to each other.

Furthermore, the present disclosure is configured to use the four corners of the top knife 30 or the bottom knife 20, which are formed at acute angles and used while rotating and being mounted without a problem in the pouch cutting quality, so that the present disclosure has an effect of prevent is prevented from requiring frequent replacement due to longer lifespan. The present disclosure is configured to utilize all four corners of the top knife 30 or the bottom knife 20 by changing the direction of at least one of the top knife 30 and the bottom knife 20 to mount the top knife 30 or the bottom knife 20, so that the present disclosure has no problem of the pouch cutting quality and an effect of more than four times the lifespan.

Meanwhile, the maximum shear load is measured in response to the combination in which, among the top knife blade of the top knife 30 and the bottom knife blade of the bottom knife 20 of the present disclosure, one blade is disposed at 90° (regular angle), and another blade is disposed at an acute angle. An object to be cut is the pouch and the time number of measurements is 10 per cutter combination and shear angle is 2°. Results of the cutting test and the shear load in response to a change of an acute angle of the blade are shown in the drawing.

As shown in the drawing, the shear load increases as an angle of the cutter blade increases, but the present disclosure is configured such that at least one of the top knife blade of the top knife 30 and the bottom knife blade of the bottom knife 20 is formed at an acute angle, so that when the pouch is cut, it is possible to prevent the shear load from increasing to prevent edges of the pouch from adhering (adhesive effect).

Meanwhile, the present disclosure is configured such that the top knife 30 and the bottom knife 20 cut the pouch while the top knife 30 is lowered with respect to the bottom knife 20, and the top knife 30 is disposed to be inclined upward with respect to the bottom knife 20, and thus when the bottom knife 20 and the top knife 30 cut the pouch like cutting a paper with scissors as the top knife 30 is lowered, the shear load is further reduced so as to be allow the pouch cutting to be efficiently performed.

### INDUSTRIAL APPLICABILITY

The present disclosure has the industrial applicability as the pouch cutter for a secondary battery, wherein the pouch cutter includes the bottom knife having the blade; and the top knife having the blade disposed to be adjacent to the blade of the bottom knife, and at least one of the blade of the bottom knife and the blade of the top knife is formed at an acute angle.

1. A pouch cutter for a secondary battery, the pouch cutter comprising:
a bottom knife (20) having a blade; and
a top knife (30) having a blade disposed to be adjacent to the blade of the bottom knife (20),
wherein at least one of the blade of the bottom knife (20) and the blade of the top knife (30) is formed at an acute angle.

2. The pouch cutter of claim 1, wherein the bottom knife (20) and the top knife (30) are cutters having square cross sections, and at least the top knife (30) from among the top knife (30) and the bottom knife (20) has a first top knife blade (35A), a second top knife blade (35B), a third top knife blade (35C), and a fourth top knife blade (35D), which are formed at acute angles so as to be adjacent to four corners of the top knife.

3. The pouch cutter of claim 2, wherein the top knife (30) is disposed to be perpendicular to the bottom knife (20), and the blade of the bottom knife (20) is formed at a regular angle, one top knife blade selected from among the first top knife blade (35A) to the fourth top knife blade (35D) of the top knife (30) is disposed to be adjacent to the blade of the bottom knife (20).

4. The pouch cutter of claim 3, wherein the top knife (30) is disposed to be inclined upward from the blade of the bottom knife (20) when seen from a first bottom knife surface (21) or a second bottom knife surface (22) of the bottom knife (20).

5. The pouch cutter of claim 4, wherein the top knife (30) has one top knife blade selected from among the first top knife blade (35A), the second top knife blade (35B), the third top knife blade (35C), and the fourth top knife blade (35D), which are formed at the acute angles to be adjacent to the four corners of the top knife, the one top knife blade being disposed to be inclined upward from the blade of the bottom knife (20).

6. The pouch cutter of claim 1, wherein the bottom knife (20) and the top knife (30) are cutters having square cross sections, and at least the bottom knife (20) from among the top knife (30) and the bottom knife (20) has a first bottom knife blade (25A), a second bottom knife blade (25B), a third bottom knife blade (25C), and a fourth bottom knife blade (25D), which are formed at acute angles so as to be adjacent to four corners of the bottom knife.

7. The pouch cutter of claim 6, wherein the top knife (30) is disposed to be perpendicular to the bottom knife (20), and the blade of the top knife (30) is formed at a regular angle, and one bottom knife blade selected from among the first bottom knife blade (25A) to the fourth bottom knife blade (25D) of the bottom knife (20) is disposed to be adjacent to the blade of the top knife (30).

8. The pouch cutter of claim 7, wherein the blade of the top knife (30) is disposed to be inclined upward from one bottom knife blade selected from among the second bottom knife blade (25B) to the fourth bottom knife blade (25D) of the bottom knife (20) when seen from a first bottom knife surface (21) or a second bottom knife surface (22) of the bottom knife (20).

9. The pouch cutter of claim 1, wherein the bottom knife (20) and the top knife (30) are cutters having square cross sections, and the top knife (30) has a first top knife blade (35A), a second top knife blade (35B), a third top knife blade (35C), and a fourth top knife blade (35D), which are formed at acute angles to be adjacent to four corners of the top knife, and the bottom knife (20) has a first bottom knife blade (25A), a second bottom knife blade (25B), a third bottom knife blade (25C), and a fourth bottom knife blade (25D), which are formed at acute angles to be adjacent to four corners of the bottom knife.

10. The pouch cutter of claim 9, wherein the top knife (30) is disposed to be perpendicular to the bottom knife (20), and one top knife blade selected from among the first top knife blade (35A) to the fourth top knife blade (35D) of the top knife (30) is disposed to be adjacent to one bottom knife blade selected from among the first bottom knife blade (25A) to the fourth bottom knife blade (25D) of the bottom knife (20).

11. The pouch cutter of claim 3, wherein one top knife blade selected from among the first top knife blade (35A) to the fourth top knife blade (35D) of the top knife (30) is disposed to be inclined upward from one bottom knife blade selected from among the first bottom knife blade (25A) to the fourth bottom knife blade (25D) of the bottom knife (20), when seen from a first bottom knife surface (21) or a second bottom knife surface (22) of the bottom knife (20).

12. An assembly method of a pouch cutter for a secondary battery, the assembly method comprising:
disposing a bottom knife (20) having a blade; and
disposing a blade of a top knife (30) such that the blade of the top knife (30) is adjacent to the blade of the bottom knife (20),
wherein at least one blade of the blade of the bottom knife (20) and the blade of the top knife (30) is formed at an acute angle.

13. The assembly method of claim 12, wherein the bottom knife (20) is disposed in a vertical direction, and the top knife (30) is disposed in a horizontal direction to be perpendicular to the bottom knife (20).
